(19) United States
(12) Patent Application Publication
(10) Pub. No.: US 2026/0004302 A1
(43) Pub. Date: Jan. 1, 2026

(54) AUTHENTICATION FOR DATA TRANSACTION MESSAGES

(71) Applicant: Motorola Mobility LLC, Chicago, IL (US)

(72) Inventors: Amit Kumar Agrawal, Bangalore (IN); Nakul Patel, Bangalore (IN); Krishnan Raghavan, Bangalore (IN)

(73) Assignee: Motorola Mobility LLC, Chicago, IL (US)

(21) Appl. No.: 18/759,799

(22) Filed: Jun. 28, 2024

(51) Int. Cl. G06Q 20/40

(52) U.S. Cl. CPC G06Q 20/4016

(57) ABSTRACT

Techniques for authentication for data transaction messages are described and are implementable to authenticate a received message that is determined to be a data transaction message. In implementations, transaction information can be extracted from the data transaction message to be used in generating an authentication request. The authentication request can be used to determine a legitimacy status of the data transaction message. The data transaction message can be processed based at least in part on the legitimacy status of the transaction message. In implementations, the data transaction message can be processed by amending the data transaction message and outputting an amended message via a mobile device.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience by offering ease of transferring funds from peer to peer, it is not without challenges. For instance, users can receive fraudulent data transaction messages that are meant to deceive users to sending funds to fraudsters. These fraudulent data transaction messages can appear as legitimate data transaction messages that transfer funds to the user's account. Fraudsters can use the fraudulent data transaction message to deceive the user to transfer funds to the fraudsters account utilizing a variety of methods.

### BRIEF DESCRIPTION OF THE DRAWINGS

Aspects of authentication for data transaction messages are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of authentication for data transaction messages can be implemented.

FIG. 2 depicts an example system for authentication for data transaction messages with one or more implementations.

FIG. 3a depicts an example graphical user interface (GUI) in accordance with one or more implementations.

FIG. 3b depicts an example GUI in accordance with one or more implementations.

FIG. 4a depicts an example GUI in accordance with one or more implementations.

FIG. 4b depicts an example GUI in accordance with one or more implementations.

FIG. 5a depicts an example GUI in accordance with one or more implementations.

FIG. 5b depicts an example GUI in accordance with one or more implementations.

FIG. 6 illustrates a flow chart depicting an example method for authentication for data transaction messages in accordance with one or more implementations.

FIG. 7 illustrates a flow chart depicting an example method for authentication for data transaction messages in accordance with one or more implementations.

FIG. 8 illustrates various components of an example device in which aspects of authentication for data transaction messages can be implemented in accordance with one or more implementations.

### DETAILED DESCRIPTION

Techniques for authentication for data transaction messages are described and are implementable to authenticate a received message that is determined to be a data transaction message. For instance, the described techniques enable users to recognize whether messages sent to a user device contain fraudulent transaction information.

In at least one implementation, a data transaction message authenticator receives a message on a mobile device and determines the message is a data transaction message. The message can be any kind of message including an SMS text message, a multimedia messaging service (MMS) message, an instant message, an email, a push notification, an application message, or any combination thereof. The data transaction message authenticator can recognize that the message is a data transaction message based at least in part on the message including transaction information and/or transaction data. The transaction information can include any information and/or data that is indicative of a transaction, such as a transfer of funds, a monetary amount of funds transferred, a date of the transaction, a time of the transaction, a source of the transaction, a destination of the transaction, and/or a user account associated with the transaction. The data transaction message authenticator may generate an authentication request to authenticate the data transaction message and/or the transaction information. The data transaction message authenticator can communicate the authentication request to a transaction service over a network.

The transaction service can be any kind of network-based service accessible by the mobile device to perform different data transactions and access previous transactions and user transaction data stored in a user account associated with the mobile device. For example, the transaction service can be implemented by a banking entity, digital payment service, enterprise entity, a trading entity, a data storage and/or management entity, and/or combinations thereof. The transaction service can receive the authentication request that includes the data transaction message and/or the transaction information extracted from the data transaction message received on the mobile device.

In one or more implementations, the transaction service authenticates the data transaction message by comparing the transaction information with the user transaction information stored in the user account by the transaction service. For example, the transaction service may perform a two-step authentication process. The first step can include determining whether the transaction information of the data transaction message includes a user account associated with the mobile device. If there is no user account found in the data transaction message, then the data transaction message may be flagged as a fraudulent message. If the transaction service locates a user account, then the transaction service can perform the second step of the authentication process. The second step can include comparing the transaction information of the data transaction message with user transaction information found in the user account. If the transaction service matches some or all the transaction information with the user transaction information, then the data transaction message can be flagged as a verified message. If the transaction service does not match some or all the transaction information with the user transaction information, then the data transaction message can be flagged a fraudulent message. The transaction service can perform the first step of the process only, the second step of the process only, or a combination of the two steps.

In response to performing the authentication process, the transaction service can generate and communicate a legitimacy status to the data transaction message authenticator and the mobile device. The legitimacy status can include information that indicates whether the data transaction message is flagged a fraudulent message or a verified message. The data transaction message authenticator can then amend the data transaction message with the legitimacy status. For example, the data transaction message authenticator may annotate the data transaction message with the legitimacy status to indicate the data transaction message is a verified message or a fraudulent message. The data transaction message authenticator may amend the data transaction message in a messaging service implemented by the mobile device and/or in a notification management hub implemented by the mobile device. Alternatively or in addition, if the data transaction message authenticator receives a legitimacy status that indicates the data transaction message is a fraudulent message, the data transaction message authenticator can automatically hide or suppress the data transaction message based on predetermined settings to block and/or hide fraudulent data transaction messages.

Accordingly, techniques described herein enable detection and authentication of transaction messages. In implementations, a transaction message represents a message that includes a data transaction. For instance, digital payment transactions involve generating, transmitting, and processing various types of data and across a variety of different systems and networks. Thus, such digital payment transactions can be characterized as sets of computational operations much like other operations of a computing device and/or set of computing devices. Accordingly, by enabling the detection and authentication of transaction messages, the described techniques can conserve system resources (e.g., memory, processor bandwidth, network bandwidth, etc.) that may otherwise be used to detect and authenticate such transaction messages, and thus the described techniques can improve the operation of computing devices and data networks. Further, user burden can be reduced by performing such authentication processes automatically while reducing user interaction to initiate and manage the authentication processes.

While features and concepts of authentication for data transaction messages can be implemented in any number of environments and/or configurations, aspects the described techniques are described in the context of the following example systems, devices, and methods. Further, the systems, devices, and methods described herein are interchangeable in various ways to provide for a wide variety of implementations and operational scenarios.

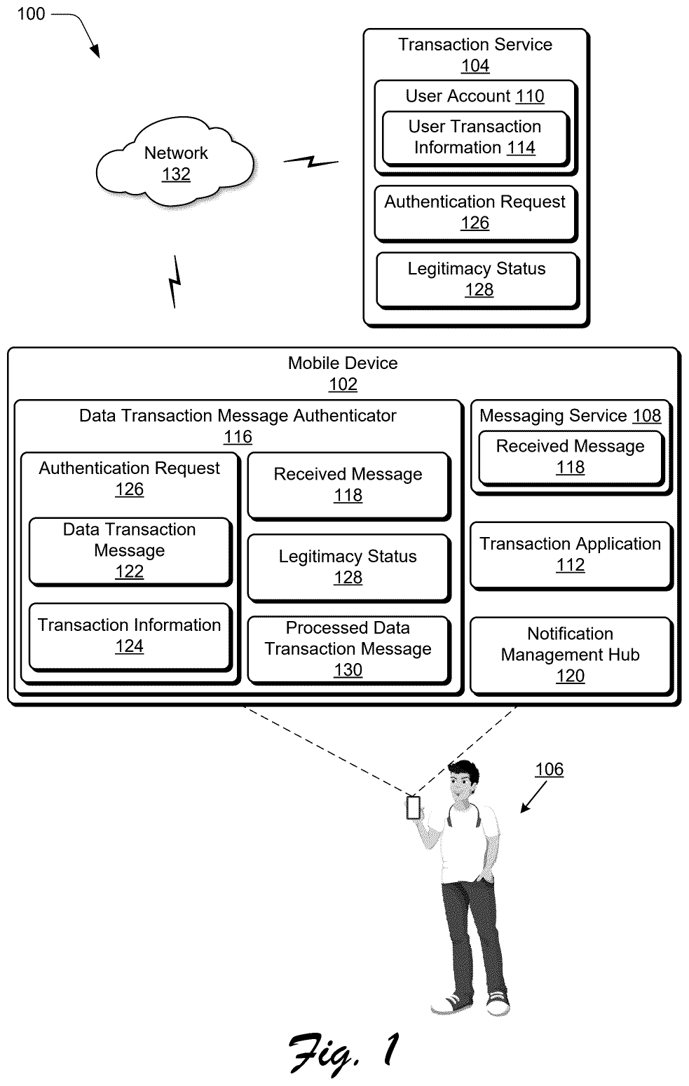

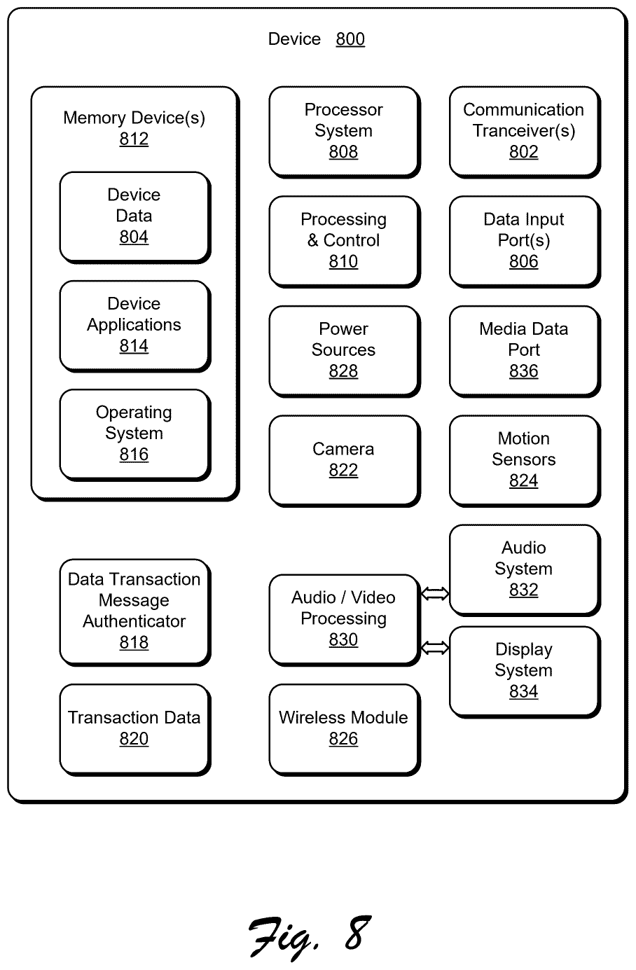

FIG. 1 illustrates an example environment 100 in which aspects of authentication for data transaction messages can be implemented. The environment 100 includes a mobile device 102 and a transaction service 104. The mobile device 102 represents any device that can be used by a user 106 to send, receive, perform, and/or manage different data messages, such as short message service (SMS) text messages, emails, and other online messages via a messaging service 108. These messages may include information indicative of a transaction that took place with a user account 110 that is associated with the mobile device 102. The mobile device 102 can represent any type of an electronic and/or computing device implemented with various components, such as a processor system and memory, as well as any number and combination of different components as further described with reference to the example device 800 shown in FIG. 8.

The transaction service 104 represents a network-based service that is accessible by the mobile device 102 to perform different data transactions. The transaction service 104 can be implemented by various entities, such as a banking entity, a digital payment service, an enterprise entity, a trading entity, a data storage and/or management entity, and/or combinations thereof. The user 106, for instance, can utilize a transaction application 112 on the mobile device 102 to access the transaction service 104 to perform different finance transactions, such as to transfer value amounts (e.g., monetary values) for different purposes, e.g., to purchase goods and/or services. The user 106 may also utilize the transaction application 112 to monitor the user account 110 that is associated with the mobile device 102 by accessing the user transaction information 114. The user transaction information 114 may include any data that is associated with transactions taking place with the user account 110 such as a transaction amount, a transaction time, a transaction source, and/or a transaction destination.

In implementations, the mobile device 102 may also implement a data transaction message authenticator 116, which may be implemented as a module that includes independent processing, memory, and/or logic components functioning as a computing and/or electronic device integrated with the mobile device. Alternatively or in addition, the data transaction message authenticator 116 can be implemented as a software application or software module, such as integrated with an operating system as computer-executable instructions that are executable with a processor of the mobile device 102. As a software application or module, the data transaction message authenticator 116 may also be implemented as one or more artificial intelligence algorithms and/or machine learning algorithms. Alternatively or in addition, the data transaction message authenticator 116 may be implemented in firmware and/or at least partially in computer hardware. For example, at least part of the data transaction message authenticator 116 may be executable by a computer processor, and/or at least part of the data transaction message authenticator may be implemented in logic circuitry.

In implementations of authentication for data transaction messages as described herein, the mobile device 102 may implement the data transaction message authenticator 116 to receive a received message 118. For example, the mobile device 102 may receive the received message 118 on the messaging service 108 from an external device that is separate from the mobile device 102. The messaging service 108 may be any type of service that is capable of sending, receiving, performing, and/or managing data messages. For example, the messaging service 108 may be an SMS text messaging service, an MMS messaging service, an instant messaging service via the internet, an email service, a push notification service, an application messaging service, or any combination thereof. In implementations, the received message 118 may be received in the messaging service 108 and/or a notification management hub 120 of the mobile device 102. The notification management hub 120 can be a service that provides an overview of alerts from any number of applications of the mobile device 102, including the messaging service 108, and provides the user 106 with management functions of such alerts. Such management functions may include viewing, deleting, responding to, and/or archiving alerts. The mobile device 102 may initiate a communication of the received message to the data transaction message authenticator 116 in response to receiving the received message.

In implementations, the data transaction message authenticator 116 can determine that the received message 118 is a data transaction message 122. For example, the data transaction message authenticator 116 may utilize text recognition software, optical character recognition software, machine learning algorithm(s), and/or artificial intelligence algorithm(s) to determine that the received message 118 is the data transaction message 122. The data transaction message 122 can be any kind of message that indicates a data transaction, such as a finance transaction to transfer value amounts (e.g., monetary values) to and/or from a user account such as the user account 110 associated with the mobile device 102. The data transaction message authenticator 116 may recognize and/or extract transaction information 124 that indicates the received message 118 is a data transaction message 122. Such transaction information 124 may include a transaction amount (e.g., a monetary amount), a date a transaction took place, a time a transaction took place, a source of a transaction, a destination of the transaction, or any combination thereof.

In implementations of authentication for data transaction messages as described herein, the data transaction message authenticator 116 implemented by the mobile device 102 may generate an authentication request 126. The data transaction message authenticator 116 may generate the authentication request 126 in response to extracting the transaction information 124 from the data transaction message 122. The authentication request 126 can include the data transaction message 122 and the transaction information 124. The mobile device 102 can communicate the authentication request 126 to the transaction service 104 to authenticate the data transaction message 122.

The transaction service 104 can receive and process the authentication request 126 to authenticate the data transaction message 122 by generating a legitimacy status 128. For example, the transaction service 104 can receive the authentication request 126 with the transaction information 124 which may or may not include the user account 110 associated with the data transaction message 122. The user account 110 may be stored in a database maintained by the transaction service 104.

In implementations, if the transaction service 104 determines that the transaction information 124 does not include the user account 110, the transaction service may generate the legitimacy status 128 to indicate that the data transaction message 122 is a fraudulent message. Alternatively, if the transaction service 104 determines that the transaction information 124 includes the user account 110, the transaction service can access the user transaction information 114 to compare with the transaction information 124. If the transaction service 104 determines that at least some of the transaction information 124 matches with the user transaction information 114, the transaction service 104 can generate the legitimacy status 128 to indicate that the data transaction message 122 is a verified message. For example, the transaction service 104 may determine that a transaction amount, transaction date, transaction time, transaction source, and/or transaction destination of the transaction information 124 is included in the user transaction information 114, and generate the legitimacy status 128 to indicate the data transaction message 122 is a verified message. If the transaction service 104 determines that the user transaction information 114 does not match some or all the transaction information 124, the transaction service can generate the legitimacy status 128 to indicate that the data transaction message 122 is a fraudulent message. The transaction service 104 may then communicate the legitimacy status 128 to the mobile device 102.

In implementations of authentication for data transaction messages as described herein, the data transaction message authenticator 116 implemented by the mobile device 102 can generate a processed data transaction message 130. The data transaction message authenticator 116 may process the data transaction message 122 and/or the received message 118 in response to receiving the legitimacy status 128 from the transaction service 104. The data transaction message authenticator 116 may process the data transaction message 122 and/or the received message 118 in any number of ways. For example, the data transaction message authenticator 116 may amend and/or annotate the data transaction message 122 and/or the received message 118 to include the legitimacy status 128. The data transaction message authenticator 116 may include the legitimacy status 128 on the received message 118 in the messaging service 108 and/or in the notification management hub 120 to be displayed via a GUI of the mobile device 102.

In implementations, the data transaction message authenticator 116 may suppress the received message 118 in response to receiving the legitimacy status 128 that indicates the data transaction message 122 is a fraudulent message. For example, the data transaction message authenticator 116 can receive user input, via a GUI of the mobile device 102, to indicate that the user 106 wishes to automatically suppress all data transaction messages that are determined to be fraudulent. The data transaction message authenticator 116 may suppress the received message 118 and/or the data transaction message 122 by hiding the received message and/or the data transaction message, and/or by moving the received message and/or the data transaction message to an alternative folder, such as a spam folder.

The mobile device 102 and the transaction service 104 can be implemented in various ways and include various functionality, examples of which care discussed below with reference to the example device 800 of FIG. 8. Further, various entities of the environment 100 can be connected and communicate via a network 132. The network 132, for example, can represent a combination of wired and wireless networks via which the mobile device 102 and the transaction service 104 can participate in various types of communication, such as wired and/or wireless data communication.

Having discussed an example environment in which the disclosed techniques can be performed, consider now an example system, scenarios, and implementation details for implementing the disclosed techniques.

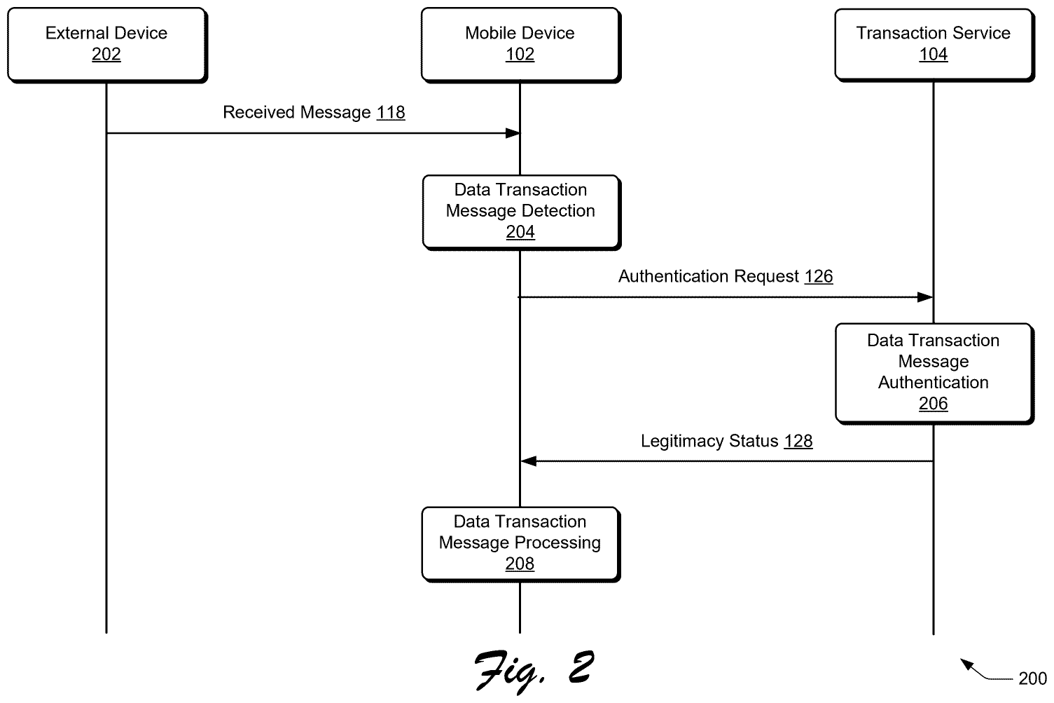

FIG. 2 depicts aspects of an example system 200 for authentication for data transaction messages with one or more implementations. The system 200 can be implemented in the environment 100 and incorporate attributes of the environment 100 above.

In the system 200, the mobile device 102 receives the received message 118 from an external device 202. The external device 202 may represent any kind of device separate from the mobile device 102 that is capable of sending and/or transmitting messages over a network such as a computing device, mobile device, tablet device, mobile device, and/or a server device. Alternatively or in addition, the mobile device 102 may receive the received message 118 from any application software installed on the mobile device, such as a push notification from a transaction service. The mobile device 102 may receive the received message 118 on a messaging service of the mobile device, such as an SMS text messaging service, an MMS service, an instant messaging service via the internet, an email service, a push notification service, an application messaging service, or any combination thereof. Alternatively or in addition, the mobile device 102 may receive the received message 118 at the notification management hub 120 of the mobile device.

Further to the system 200, the mobile device 102 may perform data transaction message detection 204 on the received message 118 to detect whether the received message is a data transaction message. For example, the data transaction message detection 204 may represent text recognition software, optical character recognition software, machine learning algorithm(s), and or artificial intelligence algorithm(s) implemented to detect that the received message 118 is a data transaction message. A data transaction message may be any kind of message associated with a data transaction, such as a finance transaction to transfer value amounts (e.g., monetary values) to and/or from a user account that may or may not be associated with the mobile device 102, a message pertaining to user account information, etc. The data transaction message detection 204 may also include extracting transaction information 124 from the received message 118 if the received message is determined to be a data transaction message. The transaction information 124 can include any data indicative of a transaction, such as a transaction amount, a transaction time, a transaction source, user account information, a transaction destination, etc. Based on the data transaction message detection 204 detecting that the received message 118 is a data transaction, the data transaction message detection 204 can further include generating the authentication request 126 by including the extracted transaction information 124 and/or the received message 118.

The mobile device 102 can communicate the authentication request 126 to the transaction service 104 to authenticate the received message 118. The transaction service 104 may represent a network-based service that is accessible to the mobile device 102 to perform different data transactions. The transaction service 104 can be implemented by various entities, such as a banking entity, a digital payment service, an enterprise entity, a trading entity, a data storage and/or management entity, and/or combinations thereof. A user of the mobile device 102 may, for instance, monitor a user account associated with the mobile device that is kept and maintained by the transaction service 104. The user account associated with the mobile device 102 may include user transaction information 114 as a record of previous data transactions made on the user account, for example. The user transaction information 114 may include any data associated with transactions taking place with the user account associated with the mobile device 102, such as a transaction amount, a transaction time, a transaction source, and/or a transaction destination.

Further to the system 200, the transaction service 104 may perform data transaction message authentication 206. In implementations, the transaction service 104 may perform the data transaction message authentication 206 in response to receiving the authentication request 126 that includes the extracted transaction information 124 and/or the received message 118. The data transaction message authentication 206 may include comparing the extracted transaction information 124 with the user transaction information 114 to generate the legitimacy status 128. The legitimacy status 128 may indicate that the received message is a verified message or a fraudulent message. For example, the data transaction message authentication 206 can generate a fraudulent message legitimacy status if the extracted transaction information 124 does not include a user account 110 associated with the mobile device 102 that can be found in the transaction service 104. Alternatively or in addition, the data transaction message authentication 206 can generate a fraudulent message legitimacy status if some or all the extracted transaction information 124 cannot be matched with the user transaction information 114. Alternatively or in addition, the data transaction message authentication 206 may generate a verified message legitimacy status if the extracted transaction information does include a user account 110 associated with the mobile device 102 that can be found in the transaction service 104. Alternatively or in addition, the data transaction message authentication 206 can generate a verified message legitimacy status if some or all the extracted transaction information 124 can be matched with the user transaction information 114.

The transaction service 104 can communicate the legitimacy status 128 to the mobile device 102. The mobile device 102 may perform data transaction message processing 208. The data transaction message processing 208 can include amending and/or annotating the received message 118 on the mobile device 102 with the legitimacy status 128 such that the legitimacy status is displayed with the received message. The data transaction message processing 208 may include the legitimacy status 128 on the received message 118 in the messaging service 108 of the mobile device 102 and/or the notification management hub 120 of the mobile device. For instance, the received message 118 can be presented with an indication of whether the received message is verified (e.g., authenticated) or determined to be potentially fraudulent. In implementations, the data transaction message processing 208 can also include suppressing the received message 118 in response to receiving the legitimacy status 128 that indicates the received message 118 is a fraudulent message.

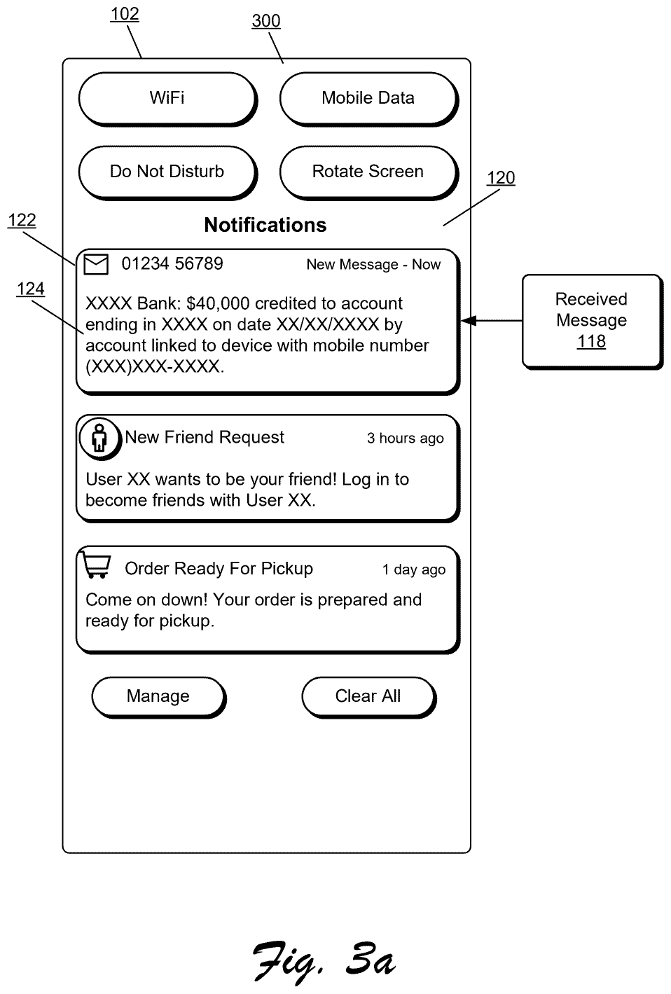

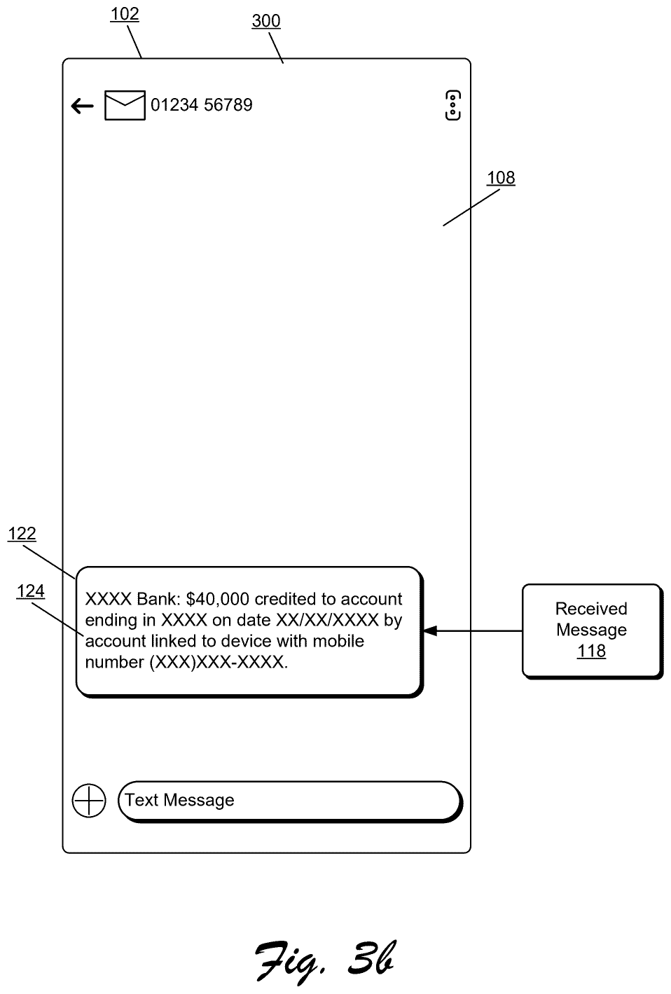

FIGS. 3a, 3b depict aspects of an example GUI 300 in accordance with one or more implementations. The GUI 300, for instance can be implemented on the mobile device 102 associated with the user 106 and incorporates attributes of the environment 100 and the example system 200 introduced above.

FIG. 3a depicts aspects of the example GUI 300 in accordance with one or more implementations. The GUI 300, for instance, can be implemented on the mobile device 102 and can be generated via the messaging service 108, the transaction application 112, etc. In this example, the GUI 300 displays the received message 118 in the notification management hub 120 on a display of the mobile device 102. The received message 118 may be an SMS text message, an MMS message, an instant message, an email, a push notification, an application message, or any combination thereof. The notification management hub 120 can be a service that provides an overview of alerts from any number of applications of the mobile device 102 (e.g., messaging service 108, the transaction application 112, etc.) and can provide the user 106 of the mobile device 102 with management functions of the alerts. Such management functions may include presenting, viewing, deleting, responding to, and/or archiving alerts. In the example GUI 300, the received message 118 can be determined to be a data transaction message 122 that includes the transaction information 124 such as described above. The transaction information 124 can include a transaction amount (e.g., a monetary amount), a date a transaction took place, a time a transaction took place, a source of a transaction, a destination of the transaction, or any combination thereof.

FIG. 3b depicts aspects of the example GUI 300 in accordance with one or more implementations. The GUI 300, for instance, can be implemented on the mobile device 102. In this example, the GUI 300 displays the received message 118 in the messaging service 108 on a display of the mobile device 102. In this example GUI 300, the received message 118 is displayed via the messaging service 108 as an SMS text message, but the received message may be any kind of message such as an MMS message, an instant message, an email, a push notification, an application message, or any combination thereof. The messaging service 108 can be any kind of service that allows a user of the mobile device 102 to view, respond to, delete, send, and/or otherwise interact with messages such as the received message 118. In this example GUI 300, the received message 118 can be determined to be a data transaction message 122 that includes the transaction information 124 as described above. The transaction information 124 can include a transaction amount (e.g., a monetary amount), a date a transaction took place, a time a transaction took place, a source of a transaction, a destination of the transaction, or any combination thereof.

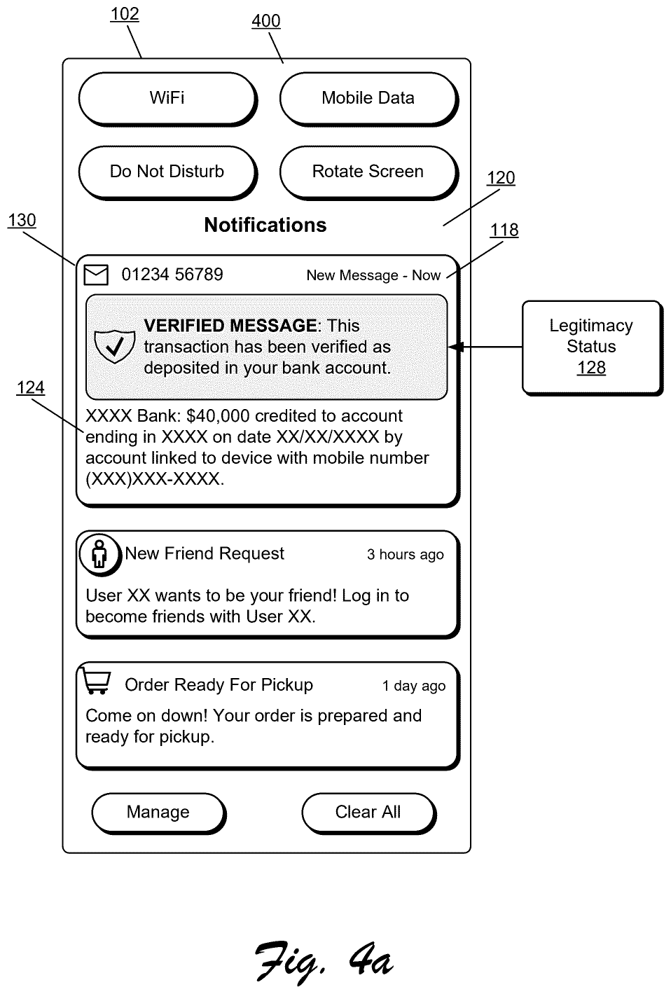

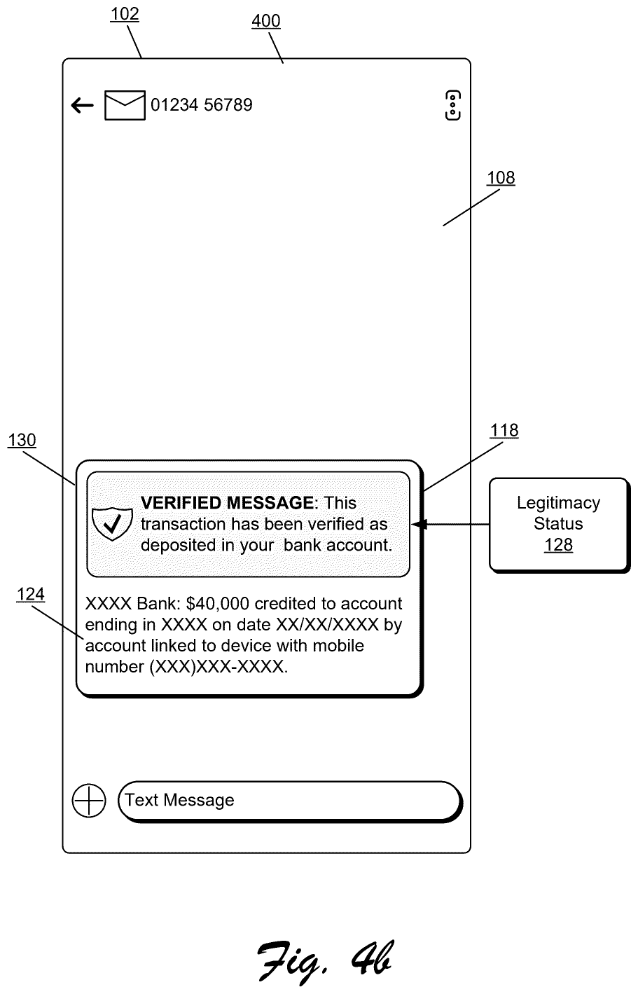

FIGS. 4a, 4b depict aspects of an example GUI 400 in accordance with one or more implementations. The GUI 400, for instance can be implemented on the mobile device 102 associated with the user 106 and incorporates attributes of the environment 100 and the system 200 introduced above.

FIG. 4a depicts aspects of the example GUI 400 in accordance with one or more implementations. The GUI 400, for instance, can be implemented on the mobile device 102. In this example, the GUI 400 displays the processed data transaction message 130 in the notification management hub 120 on a display of the mobile device 102. In this example GUI 400, the legitimacy status 128 has been communicated to the mobile device 102, for example, from the transaction service 104 as described in FIG. 1. The legitimacy status 128 can indicate whether the transaction information 124 included in the received message 118 is fraudulent or verified. In this example GUI 400, the legitimacy status 128 indicates that the received message 118 is a verified message. For example, the legitimacy status 128 may indicate that some or all the transaction information 124 has been matched with user transaction information 114 of a user account associated with the mobile device 102. In this example GUI 400, the processed data transaction message 130 is generated by amending and/or annotating the received message 118 with the legitimacy status 128 in the notification management hub 120 to indicate that the received message is a verified message.

FIG. 4b depicts aspects of the example GUI 400 in accordance with one or more implementations. The GUI 400, for instance, can be implemented on the mobile device 102. In this example, the GUI 400 displays the processed data transaction message 130 in the messaging service 108 on a display of the mobile device 102. In this example GUI 400, the processed data transaction message 130 is displayed in the messaging service 108 as an SMS text message, but the received message may be any kind of message such as an MMS message, an instant message, an email, a push notification, an application message, or any combination thereof. In this example GUI 400, the legitimacy status 128 has been communicated to the mobile device 102, for example, from the transaction service 104 as described in FIG. 1. The legitimacy status 128 can indicate whether the transaction information 124 included in the received message 118 is fraudulent or verified. In this example GUI 400, the legitimacy status 128 indicates that the received message 118 is a verified message. For example, the legitimacy status 128 may indicate that some or all the transaction information 124 has been matched with user transaction information 114 of a user account 110 associated with the mobile device 102. In this example GUI 400, the processed data transaction message 130 is generated by amending and/or annotating the received message 118 with the legitimacy status 128 in the messaging service 108 to indicate that the received message is a verified message.

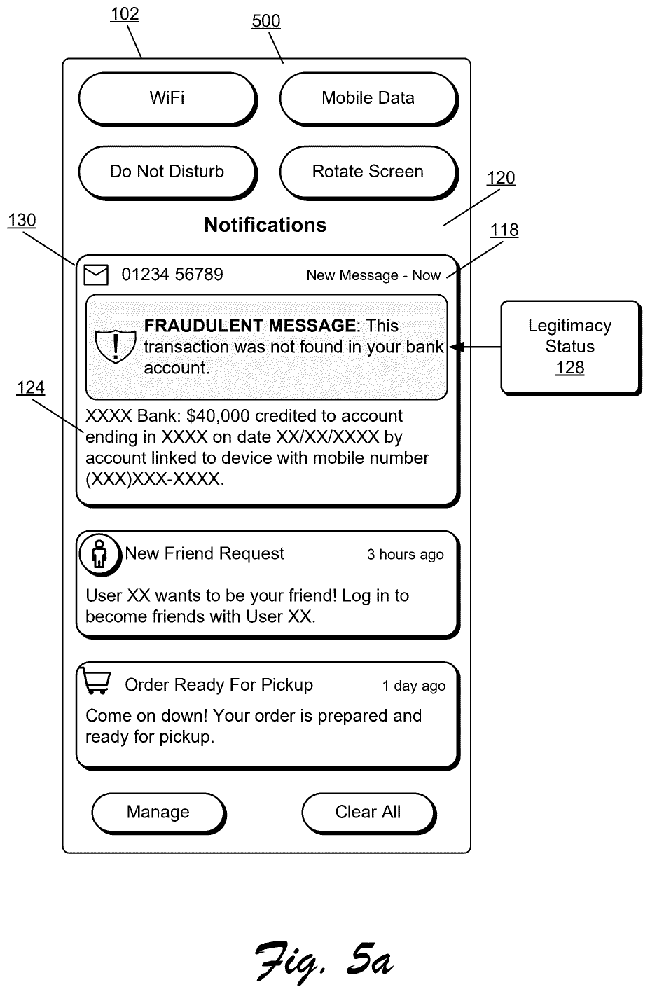

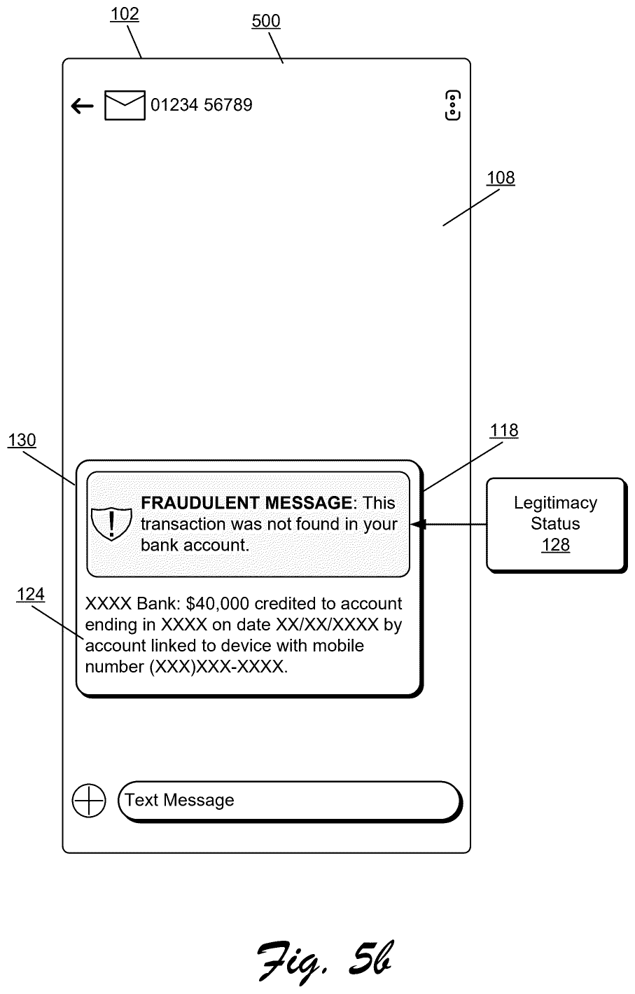

FIGS. 5a, 5b depict aspects of an example GUI 500 in accordance with one or more implementations. The GUI 500, for instance can be implemented on the mobile device 102 associated with the user 106 and incorporates attributes of the environment 100 and the system 200 introduced above.

FIG. 5a depicts aspects of the example GUI 500 in accordance with one or more implementations. The GUI 500, for instance, can be implemented on the mobile device 102. In this example, the GUI 400 displays the processed data transaction message 130 in the notification management hub 120 on a display of the mobile device 102. In this example GUI 400, the legitimacy status 128 has been communicated to the mobile device 102, for example, from the transaction service 104 as described in FIG. 1. The legitimacy status 128 can indicate whether the transaction information 124 included in the received message 118 is fraudulent or verified. In this example GUI 500, the legitimacy status 128 indicates that the received message 118 is a fraudulent message. For example, the legitimacy status 128 may indicate that some or all the transaction information 124 is missing from the user transaction information 114 of a user account 110 associated with the mobile device 102. Alternatively or in addition, the legitimacy status 128 may indicate that a user account associated with the mobile device 102 is missing from the transaction information 124. In this example GUI 500, the processed data transaction message 130 is generated by amending and/or annotating the received message 118 with the legitimacy status 128 in the notification management hub 120 to indicate that the received message is a verified message.

FIG. 5b depicts aspects of the example GUI 500 in accordance with one or more implementations. The GUI 500, for instance, can be implemented on the mobile device 102. In this example, the GUI 500 displays the processed data transaction message 130 in the messaging service 108 on a display of the mobile device 102. In this example GUI 500, the processed data transaction message 130 is displayed in the messaging service 108 as an SMS text message, but the received message may be any kind of message such as an MMS message, an instant message, an email, a push notification, an application message, or any combination thereof. In this example GUI 500, the legitimacy status 128 has been communicated to the mobile device 102, for example, from the transaction service 104 as described in FIG. 1. The legitimacy status 128 can indicate whether the transaction information 124 included in the received message 118 is fraudulent or verified. In this example GUI 500, the legitimacy status 128 indicates that the received message 118 is a verified message. For example, the legitimacy status 128 may indicate that some or all the transaction information 124 has been matched with user transaction information 114 of a user account 110 associated with the mobile device 102. In this example GUI 400, the processed data transaction message 130 is generated by amending and/or annotating the received message 118 with the legitimacy status 128 in the messaging service 108 to indicate that the received message is a verified message.

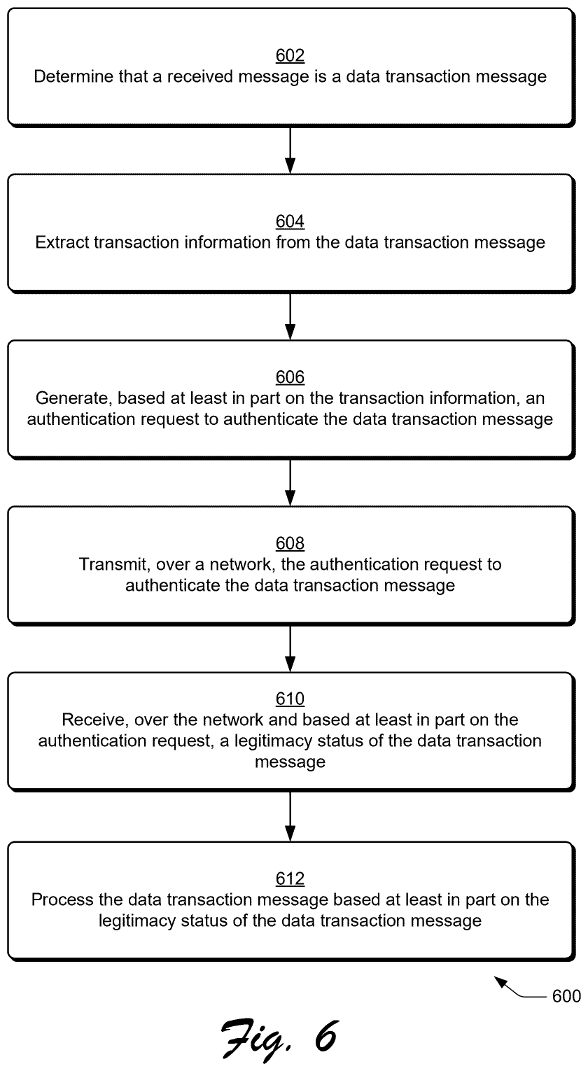

FIG. 6 illustrates a flow chart depicting an example method 600 for authentication for data transaction messages in accordance with one or more implementations. Operations of the method 600, for instance, may be performed in the context of the environment 100 and/or the system 200, such as by the mobile device 102 and/or the transaction service 104.

At 602, a received message is determined to be a data transaction message. For instance, the data transaction message authenticator 116 receives the received message 118 and determines the received message is the data transaction message 122. The data transaction message authenticator 116 may utilize text recognition software, optical character recognition software, machine learning algorithm(s), and/or artificial intelligence algorithm(s) to determine that the received message 118 is a data transaction message 122. The data transaction message 122 can be any kind of message that indicates a data transaction, such as a finance transaction to transfer value amounts (e.g., monetary values) to and/or from a user account such as the user account 110 associated with the mobile device 102. In at least one implementation, the received message is an SMS text message. For instance, the received message 118 can be an SMS text message received on the notification management hub 120 and/or the messaging service 108.

At 604, transaction information is extracted from the data transaction message. For instance, the data transaction message authenticator 116 may recognize and/or extract transaction information 124 that indicates the received message 118 is a data transaction message 122. Such transaction information 124 may include a transaction amount (e.g., a monetary amount), a date a transaction took place, a time a transaction took place, a source of a transaction, a destination of the transaction, or any combination thereof.

At 606, an authentication request is generated based at least in part on the transaction information and to authenticate the data transaction message. For instance, the data transaction message authenticator 116 implemented by the mobile device 102 may generate an authentication request 126. The data transaction message authenticator 116 may generate the authentication request 126 in response to extracting the transaction information 124 from the data transaction message 122. The authentication request 126 can include the data transaction message 122 and/or the transaction information 124.

At 608, the authentication request is transmitted over a network to authenticate the data transaction message. For instance, the data transaction message authenticator 116 can initiate the mobile device 102 communicating the authentication request 126 to the transaction service 104 over the network 132 to authenticate the data transaction message 122.

At 610, a legitimacy status of the data transaction message is received over the network based at least in part on the authentication request. For instance, the data transaction message authenticator 116 implemented by the mobile device 102 can receive the legitimacy status 128 over the network 132 from the transaction service 104. In one or more implementations, the legitimacy status indicates the data transaction message is a fraudulent message in response to determining that the transaction information does not include a user account associated with a user of the mobile device. For example, the legitimacy status 128 may indicate that the data transaction message 122 is a fraudulent message in response to determining that the transaction information 124 does not include the user account 110 associated with the mobile device 102. In one or more implementations, the legitimacy status indicates the data transaction message is a fraudulent message in response to determining that the transaction information does not include at least some user transaction information of a user account associated with a user of the mobile device. For example, the legitimacy status 128 can indicate the data transaction message 122 is a fraudulent message in response to determining that the transaction information 124 does not include at least some of the user transaction information 114 of the user account 110 associated with the mobile device 102. In one or more implementations, the legitimacy status indicates the data transaction message is a verified message in response to determining that the transaction information includes at least some user transaction information of a user account associated with a user of the mobile device. For instance, the legitimacy status 128 indicates that the data transaction message 122 is a verified message in response to determining that the transaction information 124 includes at least some of the user transaction information 114 of the user account 110 associated with the mobile device 102.

At 612, the data transaction message is processed based at least in part on the legitimacy status of the data transaction message. For instance, the data transaction message authenticator 116 generates the processed data transaction message 130 by processing the data transaction message 122 based at least in part on the legitimacy status 128. In at least one implementation, an amended message may be generated by amending the data transaction message based at least in part on the legitimacy status. The amended message can also be output via the mobile device. For example, the processed data transaction message 130 may be an amended message generated by amending the data transaction message 122 with the legitimacy status 128. The processed data transaction message 130 that is the amended message may also be output via a GUI of the mobile device 102. In at least one implementation, the amended message is generated by annotating the received message in a notification center of the mobile device. For example, the processed data transaction message 130 can be an amended message generated by annotating the received message 118 with the legitimacy status 128 in the notification management hub 120. In one or more implementations, the amended message is generated by annotating the received message in a messaging service of the mobile device. For instance, the processed data transaction message 130 can be an amended message generated by annotating the received message 118 with the legitimacy status 128 in the messaging service 108.

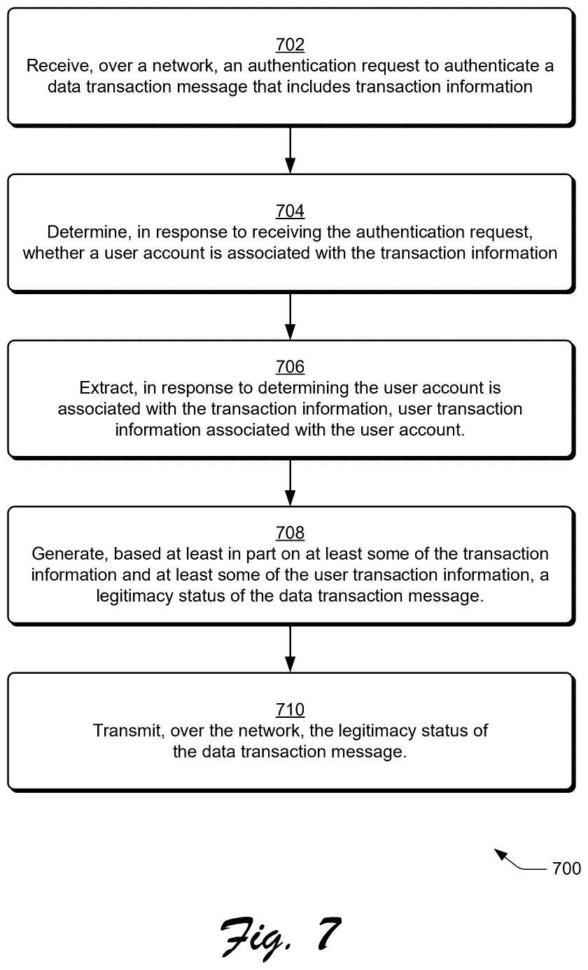

FIG. 7 illustrates a flow chart depicting an example method 700 for authentication for data transaction messages in accordance with one or more implementations. Operations of the method 700, for instance, may be performed in the context of the environment 100 and/or the system 200, such as by the mobile device 102 and/or the transaction service 104.

At 702, an authentication request is received over a network to authenticate a data transaction message that includes transaction information. For instance, the transaction service 104 receives the authentication request 126 over the network 132 to authenticate the data transaction message 122 that includes the transaction information 124 and/or the data transaction message 122. In one or more implementations, the data transaction message is a message delivered to a user device associated with the user account. For example, the data transaction message 122 can be determined from the received message 118 that is received on the mobile device 102 associated with the user account 110. In one or more implementations, the message delivered to the user device is an SMS text message. For instance, the received message 118 is an SMS text message received in the messaging service 108 and/or the notification management hub 120 of the mobile device 102.

At 704, it is determined whether a user account is associated with the transaction information in response to receiving the authentication request. For instance, the transaction service 104 determines the user account 110 is included in the transaction information 124 in response to receiving the authentication request 126 which may include the transaction information.

At 706, user transaction information associated with the user account is extracted in response to determining the user account is associated with the transaction information. For instance, the transaction service 104 extracts the user transaction information 114 from the user account 110 in response to determining that the user account is included in the transaction information 124 from the authentication request 126.

At 708, a legitimacy status of the data transaction message is generated based at least in part on at least some of the transaction information and at least some of the user transaction information. For instance, the transaction service 104 generates the legitimacy status 128 of the data transaction message 122 based at least in part on at least some of the transaction information 124 and at least some of the user transaction information 114. In at least one implementation, the legitimacy status is generated to indicate the data transaction message is a fraudulent message in response to determining that the transaction information is not associated with the user account. For instance, the transaction service 104 generates the legitimacy status 128 to indicate the data transaction message 122 is a fraudulent message in response to determining that the transaction information 124 is not associated with the user account 110.

In one or more implementations, the legitimacy status is generated to indicate the data transaction message is a fraudulent message in response to determining that the transaction information does not include at least some of the user transaction information. For example, the transaction service 104 generates the legitimacy status 128 to indicate the data transaction message 122 is a fraudulent message in response to determining that the transaction information 124 does not include at least some of the user transaction information 114. In one or more implementations, the legitimacy status is generated to indicate the data transaction message is a verified message in response to determining that the transaction information includes at least some of the user transaction information. For instance, the transaction service 104 generates the legitimacy status 128 to indicate the data transaction message 122 is a verified message in response to determining that the transaction information 124 includes at least some of the user transaction information 114.

At 710, the legitimacy status of the data transaction message is transmitted over the network. For instance, the transaction service 104 transmits the legitimacy status 128 of the data transaction message 122 to the mobile device 102 over the network 132.

The example methods described above may be performed in various ways, such as for implementing different aspects of the systems and scenarios described herein. Any services, components, modules, methods, and/or operations described herein can be implemented using software, firmware, hardware (e.g., fixed logic circuitry), manual processing, or any combination thereof. Some operations of the example methods may be described in the context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 8 illustrates various components of an example device 800 in which aspects of authentication for data transaction messages can be implemented. The example device 800 can be implemented as any of the devices described with reference to the previous FIGS. 1-7, such as any type of mobile device, mobile phone, mobile device, wearable device, tablet, computing, communication, entertainment, gaming, media playback, and/or other type of electronic device. For example, the mobile device 102 and/or the transaction service 104 as shown and described with reference to FIGS. 1-7 may be implemented as the example device 800.

The device 800 includes communication transceivers 802 that enable wired and/or wireless communication of device data 804 with other devices. The device data 804 can include any of device identifying data, device location data, wireless connectivity data, and wireless protocol data. Additionally, the device data 804 can include any type of audio, video, and/or image data. Example communication transceivers 802 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 800 may also include one or more data input ports 806 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 800 includes a processing system 808 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are identified at 810. The device 800 may further include any type of a system bus or other data and command transfer system that couples the various components within the device. A system bus can include any one or combination of different bus structures and architectures, as well as control and data lines.

The device 800 also includes computer-readable storage memory 812 (e.g., memory devices) that enable data storage, such as data storage devices that can be accessed by a computing device, and that provide persistent storage of data and executable instructions (e.g., software applications, programs, functions, and the like). Examples of the computer-readable storage memory 812 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 800 may also include a mass storage media device.

The computer-readable storage memory 812 provides data storage mechanisms to store the device data 804, other types of information and/or data, and various device applications 814 (e.g., software applications). For example, an operating system 816 can be maintained as software instructions with a memory device and executed by the processing system 808. The device applications may also include a device manager, such as any form of a control application, software application, signal-processing and control module, code that is native to a particular device, a hardware abstraction layer for a particular device, and so on. Computer-readable storage memory 812 represents media and/or devices that enable persistent and/or non-transitory storage of information in contrast to mere signal transmission, carrier waves, or signals per se. Computer-readable storage memory 812 do not include signals per se or transitory signals.

In this example, the device 800 includes a data transaction message authenticator 818 that implements aspects of authentication for data transaction messages and may be implemented with hardware components and/or in software as one of the device applications 814. For example, data transaction message authenticator 818 can be implemented via the mobile device 102 and/or the transaction service 104. In implementations, the data transaction message authenticator 818 may include independent processing, memory, and logic components as a computing and/or electronic device integrated with the device 800. The device 800 also includes transaction data 820 for implementing aspects of authentication for data transaction messages and may include data from the data transaction message authenticator 818, such as data for authenticating data transaction messages.

In this example, the example device 800 also includes a camera 822 and motion sensors 824, such as may be implemented in an inertial measurement unit (IMU). The motion sensors 824 can be implemented with various sensors, such as a gyroscope, an accelerometer, and/or other types of motion sensors to sense motion of the device. The various motion sensors 824 may also be implemented as components of an inertial measurement unit in the device.

The device 800 also includes a wireless module 826, which is representative of functionality to perform various wireless communication tasks. The device 800 can also include one or more power sources 828, such as when the device is implemented as a mobile device. The power sources 828 may include a charging and/or power system, and can be implemented as a flexible strip battery, a rechargeable battery, a charged super-capacitor, and/or any other type of active or passive power source.

The device 800 also includes an audio and/or video processing system 830 that generates audio data for an audio system 832 and/or generates display data for a display system 834. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 836. In implementations, the audio system and/or the display system are integrated components of the example device. Alternatively, the audio system and/or the display system are external, peripheral components to the example device.

Although implementations of authentication for data transaction messages have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described, and it is to be appreciated that each described example can be implemented independently or in connection with one or more other described examples. Additional aspects of the techniques, features, and/or methods discussed herein relate to one or more of the following:

In addition to the previously described methods, any one or more of the following:

In some aspects, the techniques described herein relate to a mobile device, including: at least one module; and at least one processor that is configured to execute the at least one module to cause the mobile device to: determine that a received message is a data transaction message; extract transaction information from the data transaction message; generate, based at least in part on the transaction information, an authentication request to authenticate the data transaction message; transmit, over a network, the authentication request to authenticate the data transaction message; receive, over the network and based at least in part on the authentication request, a legitimacy status of the data transaction message; and process the data transaction message based at least in part on the legitimacy status of the data transaction message.

In some aspects, the techniques described herein relate to a mobile device, wherein to process the data transaction message, the at least one processor is configured to cause the mobile device to: generate, based at least in part on the legitimacy status, an amended message by amending the data transaction message; and cause the amended message to be output via the mobile device.

In some aspects, the techniques described herein relate to a mobile device, wherein the at least one processor is configured to cause the mobile device to generate the amended message by annotating the received message in a notification center of the mobile device.

In some aspects, the techniques described herein relate to a mobile device, wherein the at least one processor is configured to cause the mobile device to generate the amended message by annotating the received message in a messaging service of the mobile device.

In some aspects, the techniques described herein relate to a mobile device, wherein the legitimacy status indicates the data transaction message is a fraudulent message in response to the transaction information not including a user account associated with a user of the mobile device.

In some aspects, the techniques described herein relate to a mobile device, wherein the legitimacy status indicates the data transaction message is a fraudulent message in response to the transaction information not including at least some user transaction information of a user account associated with a user of the mobile device.

In some aspects, the techniques described herein relate to a mobile device, wherein the legitimacy status indicates the data transaction message is a verified message in response to the transaction information including at least some user transaction information of a user account associated with a user of the mobile device.

In some aspects, the techniques described herein relate to a mobile device, wherein the received message includes one or more of a short message service (SMS) message, a multimedia messaging service (MMS) message, an instant message, an email, a push notification, or an application message.

In some aspects, the techniques described herein relate to a system including: at least one memory; and at least one processor coupled to the at least one memory and configured to cause the system to: receive, over a network, an authentication request to authenticate a data transaction message that includes transaction information; determine, in response to receiving the authentication request, whether a user account is associated with the transaction information; extract, in response to determining the user account is associated with the transaction information, user transaction information associated with the user account; generate, based at least in part on at least some of the transaction information and at least some of the user transaction information, a legitimacy status of the data transaction message; and transmit, over the network, the legitimacy status of the data transaction message.

In some aspects, the techniques described herein relate to a system, wherein the at least one processor is configured to cause the system to generate the legitimacy status to indicate the data transaction message is a fraudulent message in response to determining that the transaction information is not associated with the user account.

In some aspects, the techniques described herein relate to a system, wherein the at least one processor is configured to cause the system to generate the legitimacy status to indicate the data transaction message is a fraudulent message in response to determining that the transaction information does not include at least some of the user transaction information.

In some aspects, the techniques described herein relate to a system, wherein the at least one processor is configured to cause the system to generate the legitimacy status to indicate the data transaction message is a verified message in response to determining that the transaction information includes at least some of the user transaction information.

In some aspects, the techniques described herein relate to a system, wherein the data transaction message includes a message delivered to a user device associated with the user account.

In some aspects, the techniques described herein relate to a system, wherein the message delivered to the user device includes one or more of a short message service (SMS) message, a multimedia messaging service (MMS) message, an instant message, an email, a push notification, or an application message.

In some aspects, the techniques described herein relate to a method, including: determining that a received message is a data transaction message; extracting transaction information from the data transaction message; determining whether a user account is associated with the transaction information; extracting, in response to determining the user account is associated with the transaction information, user transaction information associated with the user account; determining a legitimacy status of the data transaction message based at least in part on at least some of the transaction information and at least some of the user transaction information; and processing the data transaction message based at least in part on the legitimacy status of the data transaction message.

In some aspects, the techniques described herein relate to a method, wherein processing the data transaction message includes: generating, based at least in part on the legitimacy status, and amended message by amending the data transaction message; and causing the amended message to be output via a mobile device associated with the user account.

In some aspects, the techniques described herein relate to a method, wherein the legitimacy status indicates the data transaction message is a fraudulent message in response to the transaction information not being associated with the user account.

In some aspects, the techniques described herein relate to a method, wherein the legitimacy status indicates the data transaction message is a fraudulent message in response to the transaction information not including at least some of the user transaction information of the user account.

In some aspects, the techniques described herein relate to a method, wherein the legitimacy status indicates the data transaction message is a verified message in response to the transaction information not including at least some of the user transaction information of the user account.

In some aspects, the techniques described herein relate to a method, wherein the received message includes one or more of a short message service (SMS) message, a multimedia messaging service (MMS) message, an instant message, an email, a push notification, or an application message received by a user device associated with the user account.

1. A mobile device, comprising:
at least one module; and
at least one processor that is configured to execute the at least one module to cause the mobile device to:
determine that a received message is a data transaction message;
extract transaction information from the data transaction message;
generate, based at least in part on the transaction information, an authentication request to authenticate the data transaction message;
transmit, over a network, the authentication request to authenticate the data transaction message;
receive, over the network and based at least in part on the authentication request, a legitimacy status of the data transaction message; and
process the data transaction message based at least in part on the legitimacy status of the data transaction message.

2. The mobile device of claim 1, wherein to process the data transaction message, the at least one processor is configured to cause the mobile device to:
generate, based at least in part on the legitimacy status, an amended message by amending the data transaction message; and
cause the amended message to be output via the mobile device.

3. The mobile device of claim 2, wherein the at least one processor is configured to cause the mobile device to generate the amended message by annotating the received message in a notification center of the mobile device.

4. The mobile device of claim 2, wherein the at least one processor is configured to cause the mobile device to generate the amended message by annotating the received message in a messaging service of the mobile device.

5. The mobile device of claim 1, wherein the legitimacy status indicates the data transaction message is a fraudulent message in response to the transaction information not including a user account associated with a user of the mobile device.

6. The mobile device of claim 1, wherein the legitimacy status indicates the data transaction message is a fraudulent message in response to the transaction information not including at least some user transaction information of a user account associated with a user of the mobile device.

7. The mobile device of claim 1, wherein the legitimacy status indicates the data transaction message is a verified message in response to the transaction information including at least some user transaction information of a user account associated with a user of the mobile device.

8. The mobile device of claim 1, wherein the received message comprises one or more of a short message service (SMS) message, a multimedia messaging service (MMS) message, an instant message, an email, a push notification, or an application message.

9. A system comprising:
at least one memory; and
at least one processor coupled to the at least one memory and configured to cause the system to:
receive, over a network, an authentication request to authenticate a data transaction message that includes transaction information;
determine, in response to receiving the authentication request, whether a user account is associated with the transaction information;
extract, in response to determining the user account is associated with the transaction information, user transaction information associated with the user account;
generate, based at least in part on at least some of the transaction information and at least some of the user transaction information, a legitimacy status of the data transaction message; and
transmit, over the network, the legitimacy status of the data transaction message.

10. The system of claim 9, wherein the at least one processor is configured to cause the system to generate the legitimacy status to indicate the data transaction message is a fraudulent message in response to determining that the transaction information is not associated with the user account.

11. The system of claim 9, wherein the at least one processor is configured to cause the system to generate the legitimacy status to indicate the data transaction message is a fraudulent message in response to determining that the transaction information does not include at least some of the user transaction information.

12. The system of claim 9, wherein the at least one processor is configured to cause the system to generate the legitimacy status to indicate the data transaction message is a verified message in response to determining that the transaction information includes at least some of the user transaction information.

13. The system of claim 9, wherein the data transaction message comprises a message delivered to a user device associated with the user account.

14. The system of claim 13, wherein the message delivered to the user device comprises one or more of a short message service (SMS) message, a multimedia messaging service (MMS) message, an instant message, an email, a push notification, or an application message.

15. A method, comprising:
determining that a received message is a data transaction message;
extracting transaction information from the data transaction message;
determining whether a user account is associated with the transaction information;
extracting, in response to determining the user account is associated with the transaction information, user transaction information associated with the user account;
determining a legitimacy status of the data transaction message based at least in part on at least some of the transaction information and at least some of the user transaction information; and
processing the data transaction message based at least in part on the legitimacy status of the data transaction message.

16. The method of claim 15, wherein processing the data transaction message comprises:
generating, based at least in part on the legitimacy status, and amended message by amending the data transaction message; and
causing the amended message to be output via a mobile device associated with the user account.

17. The method of claim 15, wherein the legitimacy status indicates the data transaction message is a fraudulent message in response to the transaction information not being associated with the user account.

18. The method of claim 15, wherein the legitimacy status indicates the data transaction message is a fraudulent message in response to the transaction information not including at least some of the user transaction information of the user account.

19. The method of claim 15, wherein the legitimacy status indicates the data transaction message is a verified message in response to the transaction information not including at least some of the user transaction information of the user account.

20. The method of claim 15, wherein the received message comprises one or more of a short message service (SMS) message, a multimedia messaging service (MMS) message, an instant message, an email, a push notification, or an application message received by a user device associated with the user account.
